(19) United States
(12) Patent Application Publication
(10) Pub. No.: US 2009/0286933 A1
(43) Pub. Date: Nov. 19, 2009

(54) EMULSION FOR VIBRATING DAMPING MATERIALS

(75) Inventors: Dai Nagaishi, Suita-shi (JP); Masaya Uchida, Suita-shi (JP)

Correspondence Address: CONNOLLY BOVE LODGE & HUTZ LLP, 1875 EYE STREET, N.W., SUITE 1100, WASHINGTON, DC, 20006, US

(73) Assignee: Nippon Shokubai Co., Ltd., Osaka (JP)

(21) Appl. No.: 12/262,870

(22) Filed: Oct. 31, 2008

(30) Foreign Application Priority Data
Nov. 2, 2007 (JP) 2007-286384

(51) Int. Cl. C09D 5/00

(52) U.S. Cl. 524/832; 524/836

(57) ABSTRACT

The present invention provides an emulsion for vibration damping materials which stably exhibits excellent vibration damping property in a wide temperature range and exhibits excellent mechanical stability and which can be preferably used in various applications where a coating vibration damping material is used. The emulsion for vibration damping materials of the present invention is an emulsion for vibration damping materials, including an emulsion obtainable by emulsion polymerization of a monomer component, wherein the emulsion has a storage modulus value of 5.0×10^{7 to 8.0×10}⁸ Pa at 20° C. and a storage modulus value of 1.0×10⁵ to 5.0×10⁶ Pa at 50° C., the emulsion has a loss modulus value of 4.0×10⁷ to 4.0×10⁸ Pa at 20° C. and a loss modulus value 1.0×10⁵ to 7.0×10⁶ Pa at 50° C., the emulsion has a maximum peak of a loss tangent of 1.3 or more in a range from 20 to 50° C., and a vibration damping composition including the emulsion has an aggregation ratio of 0.01 or less, the aggregation ratio being measured by a mechanical stability test in accordance with JIS K6828:1996.

### CROSS-REFERENCE TO RELATED APPLICATION

The present application claims priority under the Paris Convention on Patent Application No. 2007-286384 filed in Japan on Nov. 2, 2007, entitled with “EMULSION FOR VIBRATION DAMPING MATERIALS”, the entire contents of which are hereby incorporated by reference.

### BACKGROUND OF THE INVENTION

1. Field of the Invention

The present invention relates to an emulsion for vibration damping materials. More particularly, the present invention relates to an emulsion for vibration damping materials useful as a raw material for vibration damping materials used to prevent vibration and noise of various structures, thereby to insure sustained quietude.

2. Description of the Related Art

Vibration damping materials are used to prevent vibration and noise of various structures to insure sustained quietude. The vibration damping materials have been widely used beneath cabin floors of automobiles or applied to rolling stock, ships, aircraft, electric machines, buildings, construction machines, and the like. Molded products such as plate products and sheet products produced using materials having vibration absorbing performance and sound absorbing performance have been conventionally used as raw materials used for such vibration damping materials. However, it is difficult for such molded products to be used at vibration- or noise-generation positions having complicated shapes. Therefore, various methods for improving the workability and thereby sufficiently exhibiting the vibration damping property have been investigated. That is, an inorganic powder-containing asphalt sheet has been installed beneath cabin floors of automobiles, for instance, but since the sheet must be secured in position by thermal fusion, improvements in workability and the like are needed. Therefore, studies on various compositions or polymers for vibration damping for forming the vibration damping materials have been made.

Coating vibration damping materials (coating materials) have been developed as an alternative material for such molded products. For example, the following vibration damping coating material has been variously proposed: a vibration damping coating material is sprayed onto positions to be subjected to damping treatment with a spray or applied thereto by any method, and the thus-formed coating film can give a vibration absorbing effect and a sound absorbing effect. Specifically, an aqueous vibration damping coating material prepared by the following manners: mixing synthetic resin powders with a vehicle such as asphalt, rubber, and synthetic resin; and improving the hardness of the obtained coating film, has been developed. In addition, as materials suitably used for interior parts of cars, vibration damping coating materials prepared by dispersing activated carbon as a filler into a resin emulsion has been developed. Such vibration damping coating materials and the like need to be excellent in vibration damping property and mechanical stability. However, these conventional items are still insufficient in vibration damping performances. Therefore, a technology which enables vibration damping materials to exhibit more sufficient vibration damping performances in addition to excellent mechanical stability has been desired. Particularly, a vibration damping material which can stably exhibit excellent vibration damping property at 20 to 60° C. where such a vibration damping coating material and the like is used and also exhibit excellent mechanical stability has been desired.

As a conventional vibration damping material which is aimed to exhibit a vibration damping property in a wide temperature range, for example, Japanese Kokai Publication No. 2006-335938 (pages 1 and 2) discloses an aqueous acrylic emulsion including an aqueous medium and emulsion particles composed of an acrylic polymer (A) dispersed into the aqueous medium, wherein storage modulus values and loss modulus values at 20° C. and 60° C., and the maximum tan δ peak in a temperature range from 20 to 60° C. of the acrylic polymer (A) are specified (for example, refer to Patent Document 1). However, such an aqueous acrylic emulsion still has room for improvement in order to be used as a vibration damping material which exhibits excellent damping property in a wide temperature range and further excellent mechanical stability.

### SUMMARY OF THE INVENTION

The present invention has been made in view of the above-mentioned state of the art. The present invention has an object to provide the following emulsion for vibration damping materials. The emulsion stably exhibits excellent vibration damping property in a wide temperature range and also excellent mechanical stability. Further, such an emulsion can be preferably used in various applications where a coating vibration damping material is used.

The present inventors made various investigations on an emulsion for vibration damping materials which is preferably used in a vibration damping coating material which exhibits excellent physical properties such as a vibration damping property at 20 to 60° C. where the coating material is generally used. The inventors found that if an inorganic pigment is added to the emulsion as a component to provide a vibration damping composition, the composition has an improved hardness, and in such a case, there is a correlation between vibration damping property at 60° C. of thus-prepared vibration damping composition and a storage modulus value and a loss modules value of the emulsion at 50° C. Further, the present inventors found the followings. If an emulsion (emulsion polymer) prepared by emulsion polymerization of a monomer component has storage modulus values and loss modulus values at 20° C. and 50° C. within a specific range and has a specific value or more of the maximum peak of a loss tangent at 20 to 50° C., and a vibration damping composition including such an emulsion shows a specific value or less of an aggregation ratio measured in a mechanical stability test in accordance with JIS K 6828: 1996, the obtained emulsion exhibits excellent vibration damping property stably in a wide temperature range, and has excellent mechanical stability. In addition, the inventors found that if the minimum film-forming temperature of such an emulsion is a specific temperature or less, generation of defects in a coating film formed by the emulsion can be suppressed, and a coating film which exhibits more sufficient vibration damping property and mechanical stability in various applications where the emulsion for vibration damping materials can be used. As a result, the above-mentioned problems have been admirably solved, leading to completion of the present invention.

That is, the present invention is an emulsion for vibration damping materials, comprising an emulsion obtainable by emulsion polymerization of a monomer component, wherein the emulsion has a storage modulus value of 5.0×10⁷ to 8.0×10⁸ Pa at 20° C. and a storage modulus value of 1.0×10⁵ to 5.0×10⁶ Pa at 50° C., the emulsion has a loss modulus value of 4.0×10⁷ to 4.0×10⁸ Pa at 20° C. and a loss modulus value 1.0×10⁵ to 7.0×10⁶ Pa at 50° C., the emulsion has a maximum peak of a loss tangent of 1.3 or more in a range from 20 to 50° C., and a vibration damping composition including the emulsion has an aggregation ratio of 0.01 or less, the aggregation ratio being measured by a mechanical stability test in accordance with JIS K6828:1996.

The present invention is mentioned below in more detail.

The emulsion for vibration damping materials of the present invention includes an emulsion obtainable by emulsion polymerization of a monomer component, the following values of the emulsion are specified: storage modulus values at 20° C. and 50° C.; loss modulus values at 20° C. and 50° C.; the maximum peak of a loss tangent, and a range where the maximum peak is observed; and an aggregation ratio measured by subjecting a vibration damping composition including the emulsion to a mechanical stability test in accordance with JIS K6828:1996. Each of the storage modulus and the loss modulus of the emulsion is an index of a hardness and a consumption of vibrational energy due to internal friction. If the values of the storage modulus and the loss modulus are larger than the upper limit of those of the emulsion of the present invention, a coating film becomes hard, and the film-forming property is reduced. If these values are lower than the lower limit, the vibration damping property might not be exhibited. The maximum peak of a loss tangent is an index of a degree of vibrational energy consumption. These have an influence on the vibration damping property of the emulsion. The emulsion exhibits a desired vibration damping property under the following conditions: the storage modulus values at 20° C. and 50° C. and the loss modulus values at 20° C. and 50° C. are within specific ranges, respectively, and a specific value or more of the maximum peak of a loss tangent is observed at 20° C. to 50° C., and a vibration damping composition including the emulsion has a specific aggregation ratio measured by a mechanical stability test in accordance with JIS K6828:1996.

The kind of the emulsion for vibration damping materials of the present invention is not especially limited as long as the storage modulus values at 20° C. and 50° C. and the loss modulus values at 20° C. and 50° C., the maximum peak of a loss tangent, and the range where the maximum peak is observed satisfy specific values, respectively, and also a vibration damping composition including the emulsion satisfies a specific aggregation ratio measured by a mechanical stability test in accordance with JIS K6828:1996. The emulsion for vibration damping materials of the present invention may include one or more different emulsions prepared by emulsion polymerization of the monomer component. If the emulsion for vibration damping materials include two or more different emulsions, the emulsion for vibration damping materials may include an emulsion not satisfying the above-mentioned specific values, i.e., other emulsions, as long as at least one of the two or more different emulsions satisfy the above-mentioned specific values.

Other emulsion resins mentioned below and the like can be used as other emulsions.

The above-mentioned aggregation ratio is measured by subjecting the vibration damping composition to a mechanical stability test in accordance with JIS K6828:1996. Specifically, the aggregation ratio is measured by the following method, for example.

The vibration damping composition is subjected to a mechanical stability test in accordance with JIS K 6828:1996 with a Maron stability tester (KUMAGAI RIKI KOGYO Co., Ltd.). Immediately after the test, the vibration damping composition was filtered through a 100 metal mesh, and dried for 1 hour at 110° C. in a drying oven. The aggregation ratio of the vibration damping composition is calculated from the following formula.

Aggregation ratio (%)=(mass of metal mesh after drying (g)−mass of metal mesh before drying (g))/70 (g)×100

According to the emulsion for vibration damping materials of the present invention, as mentioned above, the values of the various physical properties are within specific ranges, respectively. Such an emulsion can be prepared by the following manner (1) or (2), for example. (1) Polymerization reaction is performed by appropriately determining monomer components forming the emulsion or reaction conditions in such a way that the entire emulsion has a glass transition temperature (Tg) of −20 to 30° C., and a weight average molecular weight of the emulsion is within 10000 to 200000; or (2) Polymerization reaction is performed using the below-mentioned emulsion having a core-shell composite structure as the emulsion by appropriately determining monomer components forming the emulsion in such a way that the entire emulsion has a glass transition temperature (Tg) of −20 to 30° C., and a difference in Tg between a monomer component forming a core part and a monomer component forming a shell part is 10 to 60° C.

It is preferable that the emulsion has a storage modulus value of 6.0×10⁷ to 7.0×10⁸ Pa at 20° C. If the storage modulus value at 20° C. is within such a range, a loss coefficient of the emulsion at 20° C. is large, and as a result, the vibration damping property of a coating film at 20° C. is improved. The storage modulus value at 20° C. is more preferably 7.0×10⁷ to 6.0×10⁸ Pa.

Further, it is preferable that the emulsion has a storage modulus value of 2.0×10⁵ to 4.0×10⁶ Pa at 50° C. If the storage modulus value at 50° C. is within such a range, a coating composition (vibration damping composition) prepared by adding a pigment and the like to the emulsion has a larger loss coefficient at 60° C., and as a result, the coating film has improved vibration damping property at 60° C. The storage modulus value at 50° C. is more preferably 3.0×10⁵ to 3.0×10⁶ Pa.

It is preferable that the emulsion has a loss modulus value of 5.0×10⁷ to 3.0×10⁸ Pa at 20° C. If the loss modulus value at 20° C. is within such a range, a loss coefficient of the emulsion at 20° C. is large, and as a result, the coating film has improved vibration damping property at 20° C. The loss modulus value at 20° C. is more preferably 6.0×10⁷ to 2.0×10⁸ Pa.

Further, it is preferable that the emulsion has a loss modulus value of 2.0×10⁵ to 6.0×10⁶ Pa at 50° C. If the loss modulus value at 50° C. is within such a range, a coating composition prepared by adding a pigment and the like to the emulsion has a larger loss coefficient at 60° C., and as a result, the coating film has improved vibration damping property at 60° C. The loss modulus value at 50° C. is more preferably 3.0×10⁵ to 5.0×10⁶ Pa.

It is more preferable that the emulsion has a storage modulus value of 6.0×10⁷ to 7.0×10⁸ Pa at 20° C. and a storage modulus value of 3.0×10⁵ to 4.0×10⁶ Pa at 50° C., and has a loss modulus value of 5.0×10⁷ to 3.0×10⁸ Pa at 20° C. and a loss modulus value of 2.0×10⁵ to 6.0×10⁶ Pa at 50° C. If the storage modulus values and the loss modulus values at 20° C. and 50° C. are within the above-mentioned ranges, respectively, a coating composition prepared by adding a pigment and the like to the emulsion exhibits more excellent vibration damping property at 20 to 60° C.

It is preferable in the above-mentioned emulsion that a difference in absolute value between the storage modulus value and the loss modulus value at 20° C. is less than 5.0×10⁸ Pa. If this difference is 5.0×10⁸ Pa or more, a polymer constituting the coating film gets stiff and the vibration damping property might not be exhibited.

Similarly, it is preferable in the above-mentioned emulsion that a difference in absolute value between the storage modulus value and the loss modulus value at 50° C. is less than 2.5×10⁵ Pa.

The above-mentioned emulsion has the maximum peak of a loss tangent of 1.3 or more in a range from 20 to 50° C. It is preferable that the temperature where the maximum peak of a loss tangent of 1.3 or more is observed is 25 to 45° C. If the temperature where the maximum peak of a loss tangent of 1.3 or more is observed is within such a range, a loss coefficient of a coating composition prepared by adding a pigment and the like to the emulsion at 20 to 60° C. is improved and desired vibration damping property is exhibited. More preferably, the temperature is 30 to 40° C. The above-mentioned storage modulus value, loss modules value, and a loss tangent can be measured, for example, by subjecting a film prepared using the emulsion for vibration damping materials to dynamic mechanical analysis with a strain controlled solid dynamic mechanical analysis instrument, RSA-III (product of TA Instruments, Inc.).

It is preferable that the above-mentioned emulsion has a loss tangent of 0.15 or more at 20° C. More preferably, the loss tangent at 20° C. is 0.4 or more.

Further, it is preferable that the above-mentioned emulsion has a loss tangent of 0.4 or more at 50° C. More preferably, the loss tangent at 50° C. is 0.6 or more.

If the loss tangent at 20° C. or the loss tangent at 50° C. is within such a preferable range, a coating composition prepared by adding a pigment and the like to the emulsion exhibits an excellent controllability at near 20° C. or 60° C. Further, if the loss tangent at 20° C. and the loss tangent at 50° C. are within such preferable ranges, respectively, a coating composition prepared by adding a pigment and the like to the emulsion exhibits an excellent vibration damping property at 20 to 60° C.

It is preferable that the emulsion has a minimum film-forming temperature of 30° C. or less. If the minimum film-forming temperature is larger than 30° C., defects are generated in the coating film in a temperature range where the emulsion for vibration damping materials is used, and a sufficient vibration damping property might not be exhibited.

More preferably, the minimum film-forming temperature is 20° C. or less.

The above-mentioned emulsion for vibration damping materials exist in the form of particles of a polymer obtained by emulsion polymerization of a monomer component, dispersed into a medium. An aqueous medium is preferable as the medium. Examples thereof include water and mixed solvents of water and a water-miscible solvent. Among these, water is preferred in view of influence on environment or safety, which may be caused by use of a coating material containing the emulsion for vibration damping materials of the present invention.

It is preferable that a nonvolatile content in the above-mentioned emulsion for vibration damping materials, that is, the content of the emulsion particles having the specific storage modulus value and the like is 30% by weight or more and 70% by weight or less relative to 100% by weight of the total amount of the emulsion for vibration damping materials. If the content is more than 70% by weight, the viscosity of the emulsion for vibration damping materials becomes too high, and thereby, the emulsion may not maintain sufficient dispersion stability and then aggregate. If the content is less than 30% by weight, sufficient vibration damping property might not be exhibited. The content is more preferably 50% by weight or more and 65% by weight or less.

If the emulsion for vibration damping materials includes an emulsion other than the above-mentioned emulsion having the specific storage modulus value and the like, it is preferable that a nonvolatile content in the entire emulsion for vibration damping materials of the present invention, including the emulsion having the specific storage modulus value and the like and another emulsion, satisfies the above-mentioned value.

The emulsion for vibration damping materials of the present invention is obtainable by emulsion polymerization of the monomer component, and the emulsion includes the emulsion having the specific storage modulus value and the like. The use amount of an emulsifier is preferably 1.0 part by weight or more relative to 100 parts by weight of the total amount of the monomer component used for producing the emulsion obtainable by emulsion polymerization of the monomer component. If the use amount is less than 1.0 part by weight, the emulsion can not exhibit excellent drying property and vibration damping property. Further, if the emulsion is mixed with a pigment, they might not be sufficiently mixed with each other. The emulsion might not be useful for vibration damping materials of various structures. The use amount of the emulsifier is preferably 2.0 parts by weight or more and more preferably 2.5 parts by weight or more. The use amount thereof is also preferably 7.0 parts by weight or less in view of economic efficiency.

Emulsifiers which are commonly used for emulsion polymerization may be used as the emulsifier used for producing the above-mentioned emulsion having the specific storage modulus value and the like. One or more species of various surfactants such as below-mentioned anionic, nonionic, cationic, amphoteric, and polymer surfactants can be used. Among these, surfactants with reactivity, that is, reactive emulsifiers are preferably used.

If a reactive emulsifier is used as the emulsifier, blisters which are generated by heat at the time of drying because the emulsifier is liberated into water and bleeds to the coating film surface, are suppressed. Further, the stability and dispersibility of the emulsion can be improved, and thereby the vibration damping property can be improved.

The emulsifier used for producing the above-mentioned emulsion for vibration damping materials may contain both of the reactive emulsifier and an emulsifier other than the reactive emulsifier, but it is preferable that the emulsifier contains the reactive emulsifier as a main component.

Polymerizable group-containing anionic emulsifiers, polymerizable group-containing nonionic emulsifiers and the like are preferable as the reactive emulsifier. One or more species of them may be used. Among these, an emulsifier containing a polymerizable group such as a vinyl group, an allyl group, a (meth) acryloyl group and a propenyl group is preferable.

Preferable examples of the above-mentioned polymerizable group-containing anionic emulsifiers include: bis(polyoxyethylene polycyclic phenyl ether)methacrylated sulfonate (e.g., product of Nippon Nyukazai Co., Ltd., “ANTOX MS-60”), propenyl-alkylsulfosuccinate, (meth)acrylic acid polyoxyethylene sulfonate, (meth) acrylic acid polyoxyethylene sulfonate (e.g., product of Sanyo Chemical Industries, Ltd., “ELEMINOLRS-30”), an allyl group-containing sulfate (salt) such as allyloxymethyl alkyloxy polyoxyethylene sulfonate (e.g., product of DAI-ICHI KOGYO SEIYAKU CO., LTD., “AQUALON KH-10”), allyloxy methylalkoxyethyl polyoxyethylene sulfate (e.g., product of ADEKA Corp., “ADEKAREASOAP SR-10”), polyoxyalkylene alkenyl ether ammonium sulfate (for example, product of Kao Corp., “LATEMUL PD-104”).

LATEMUL S-120, S-120A, S-180 and S-180A (trade name, products of Kao Corp.), ELEMINOL JS-2 (trade name, product of Sanyo Chemical Industries, Ltd.), and the like, which are sulfosuccinate reactive anionic surfactants are also preferable. Further, LATEMUL ASK (trade name, product of Kao Corp.), which is an alkenyl succinate reactive anionic surfactant, is also preferable.

The following surfactants are preferably used as the anionic emulsifier that is a reactive emulsifier.

C₃ to C₅ aliphatic unsaturated carboxylic acid sulfoalkyl (containing 1 to 4 carbon atoms) ester surfactants, for example, (meth)acrylic acid sulfoalkyl ester salt surfactants such as 2-sulfoethyl(meth)acrylate sodium salt and 3-sulfopropyl (meth)acrylate ammonium salt; and aliphatic unsaturated dicarboxylic acid alkyl sulfoalkyl diester salt surfactants such as sulfopropylmaleic acid alkyl ester sodium salt, sulfopropylmaleic acid polyoxyethylene alkyl ester ammonium salt and sulfoethylfumaric acid polyoxyethylene alkyl ester ammonium salt;

maleic acid dipolyethylene glycol ester alkylphenol ether sulfate; phthalic acid dihydroxyethyl ester (meth)acrylate sulfate; 1-allyloxy-3-alkyl phenoxy-2-polyoxyethylene sulfate (trade name: ADEKA REASOAP SE-10N, product of ADEKA Corp.), and polyoxyethylene alkylalkenylphenol sulfate (trade name: AQUALON, product of DAI-ICHI KOGYO SEIYAKU CO., LTD.).

Preferable examples of the above-mentioned polymerizable group-containing nonionic emulsifiers include: allyloxymethyl alkoxy ethyl hydroxy polyoxyethylene (for example, “ADEKA REASOAP ER-20”, product of ADEKA Corp.); and polyoxyalkylene alkenylether (for example, “LATEMULPD-420” and “LATEMULPD-430”, products of Kao Corp.).

Among the above-mentioned reactive emulsifiers, ANTOX MS-60 (trade name, product of Nippon Nyukazai Co., Ltd.), ADEKA REASOAP SR-10, SR-20, and SR-30 (trade name, products of ADEKA Corp.), AQUALON KH-10 (trade name, product of DAI-ICHI KOGYO SEIYAKU CO., LTD.), and LATEMUL PD-104 (trade name, product of Kao Corp.) are particularly preferable as the reactive emulsifier used for producing the emulsion for vibration damping materials of the present invention.

If the emulsion obtained using these reactive emulsifiers is used, the characteristics of the emulsion for vibration damping materials of the present invention can be more effectively exhibited.

In the present invention, it is preferable that a reactive emulsifier having an addition structure of ethylene oxide is used because the emulsion for vibration damping materials becomes excellent in mixing property with a pigment, a filler, and the like. A stability of the emulsion for vibration damping materials to a pigment, a filler, and the like might be improved due to the addition structure of ethylene oxide.

An anionic emulsifier having a specific structure is also preferable as the above-mentioned emulsifier used for producing the emulsion having the specific storage modulus value and the like.

Such an anionic emulsifier is a sulfate compound or a succinate compound, and the sulfate compound contains at least one selected from the group consisting of aliphatic alkyl groups containing 8 or more carbon atoms, oleyl groups, alkyl phenyl groups, styryl groups, and benzyl groups. More preferable examples of the aliphatic alkyl groups containing 8 or more carbon atoms include aliphatic alkyl groups containing 12 or more carbon atoms and aliphatic alkyl groups containing one or more aromatic rings.

Among the above-mentioned anionic emulsifiers having a specific structure, it is preferable that the anionic emulsifier is at least one selected from the group consisting of polyoxyalkylene alkyl ether sulfate, polyoxyalkylene oleyl ether sodium sulfate, polyoxyalkylene alkylphenyl ether sulfate, alkyl diphenyl ether disulfonate, polyoxyalkylene (mono, di, tri)styryl phenyl ether sulfate, polyoxyalkylene (mono, di, tri)benzyl phenyl ether sulfate, and alkenyl disuccinate.

These anionic emulsifiers each exhibit the same effects because each has a skeleton with strong hydrophobicity. Use of these anionic emulsifiers enables the emulsion for vibration damping materials of the present invention to more effectively exhibit the characteristics.

The polyoxyalkylene (mono, di, tri)styryl phenyl ether sulfate means any one of polyoxyalkylene monostyryl phenyl ether sulfate, polyoxyalkylene distyryl phenyl ether sulfate, and polyoxyalkylene tristyryl phenyl ether sulfate. The polyoxyalkylene (mono, di, tri)benzylphenyl ether sulfate means any one of polyoxyalkylene monobenzyl phenyl ether sulfate, polyoxyalkylene dibenzyl phenyl ether sulfate, and polyoxyalkylene tribenzyl phenyl ether sulfate.

Among the above-mentioned compounds, the above-mentioned anionic emulsifier having a specific structure is preferably at least one selected from the group consisting of: polyoxyethylene alkyl ether sulfate, polyoxyethylene alkyl phenyl ether sodium sulfate, polyoxyethylene (mono, di, tri)styryl phenyl ether sulfate, andpolyoxyethylene (mono, di, tri)benzyl phenyl ether sulfate, each having an ethylene oxide chain in which an average molar number of addition of ethylene oxide is 15 to 35.

Particularly preferable compounds as these anionic emulsifiers are mentioned as follows, in addition to the above-mentioned reactive emulsifiers: LATEMULWX, LATEMUL 118B, PELEX SS-H, EMULGEN 1118S, EMULGEN A-60, B-66 (products of Kao Corp.), NEWCOL 707SF, NEWCOL 707SN, NEWCOL 714SF, NEWCOL 714SN (products of Nippon Nyukazai Co., Ltd.), ABEX-26S, ABEX-2010, 2020 and 2030, and DSB (products of Rhodia Nikka Co., Ltd.). Further, surfactants which are nonionic type of these emulsifiers may be also used.

Among these, LATEMUL WX is most preferably used.

In the present invention, the above-mentioned anionic emulsifier having a specific structure and the reactive emulsifier may be used in combination. In addition, the above-mentioned anionic emulsifier having a specific structure and other commonly used anionic emulsifiers may be used in combination. The other commonly used anionic emulsifiers are not especially limited, and one or more species of the below-mentioned anionic surfactants may be used.

It is preferable that particles of the emulsion having the specific storage modulus value and the like of the present invention are emulsion particles each having a core part and a shell part. If the emulsion has such an embodiment, the emulsion may have a homogeneous structure in which the core part and the shell part are completely compatible with each other and therefore they can not be distinguished from each other, or a core-shell composite structure or a microdomain structure, in which the core part and the shell part are not completely compatible with each other and heterogeneously formed.

Among these structures, the core-shell composite structure is preferable in order for the emulsion to sufficiently exhibit the characteristics and to be stably produced.

The above-mentioned core-shell composite structure preferably has a form in which the surface of the core part is covered with the shell part. It is preferable that the surface of the core part is perfectly covered with the shell part, especially. However, the surface of the core part may not be perfectly covered. For example, the core-shell composite structure may have a form in which the surface of the core part is covered in a mesh-like state or a form in which the core part is not covered in some parts.

In the above-mentioned emulsion particle having a core part and a shell part, a polymer forming the core part and a polymer forming the shell part are different in any of various properties such as weight average molecular weight, glass transition temperature, SP value (solubility coefficient), kind of a used monomer, and a proportion of the monomer. Among these, it is preferable that the two polymers are different in at least one of the weight average molecular weight and the glass transition temperature, as mentioned below.

It is preferable that the emulsion having the specific storage modulus value and the like of the present invention has a glass transition temperature (Tg) of −20 to 30° C. Further, it is preferable that the entire emulsion for vibration damping material has a glass transition temperature within this range. In these embodiments, if a vibration damping composition is formed using the emulsion for vibration damping materials of the present invention, the vibration damping composition has a suitable loss coefficient and thereby it can exhibit excellent vibration damping property. If the above-mentioned Tg is less than −20° C. or more than 30° C., the vibration damping property might be insufficient. The Tg is more preferably −10° C. or more and 20° C. or less. The Tg is still more preferably −5° C. or more and 10° C. or less.

If the above-mentioned emulsion particles are emulsion particles each having a core part and a shell part, it is preferable that a difference in glass transition temperature (Tg) between a monomer component forming the core part and a monomer component forming the shell part is 10 to 60° C. If the difference in Tg is less than 10° C. or more than 60° C., the vibration damping property in a wide temperature range (20° C. to 60° C.) might not be obtained. The difference in Tg is more preferably 15 to 50° C. It is preferable that the Tg of the monomer component forming the core part is higher than the Tg of the monomer component forming the shell part. That is, if the emulsion having the core part and the shell part is produced, such an emulsion is produced by the following multi-stage polymerization: the emulsion forming the core part is formed; and then the emulsion forming the shell part is formed. It is preferable that the Tg of the monomer component used in the former step is higher than the Tg of the monomer component used in the latter step. Also if the emulsion is produced in three or more stages, it is preferable that the Tg of the monomer component used in one step is lower than the Tg of the monomer component used in the last step.

It is preferable that the emulsion for vibration damping materials of the present invention essentially includes an emulsion having a high Tg. Further, it is preferable that the emulsion for vibration damping materials of the present invention includes an emulsion having a high Tg and an emulsion having a low Tg.

An emulsion having a Tg of 0° C. or more and 50° C. or less is preferable as the above-mentioned emulsion having a high Tg. An emulsion having a Tg of 0° C. or more and 30° C. or less is more preferable as the above-mentioned emulsion having a high Tg. An emulsion having a Tg of −50° C. or more and 10° C. or less is preferable as the above-mentioned emulsion having a low Tg. An emulsion having a Tg of −20° C. or more and 0° C. or less is preferable as the above-mentioned emulsion having a low Tg.

The difference in Tg between the emulsion having a high Tg and the emulsion having a low Tg is preferably 15° C. or more. If the difference in Tg is less than 15° C., the vibration damping property might not be more sufficiently exhibited at 20° C. or 60° C. The difference in Tg is more preferably 20° C. or more and still more preferably 25° C. or more. The vibration damping property within the practical range may be insufficient if the difference is too large. The difference in Tg is preferably 100° C. or less, and more preferably 90° C. or less, and still more preferably 80° C. or less.

Such a difference in Tg makes it possible for the emulsion for vibration damping materials to exhibit higher vibration damping property in a wide temperature range. Particularly in a practical range of 20 to 60° C., the vibration damping property is dramatically improved. If three or more different emulsions are used, at least two different emulsions are different in Tg, and the rest one or more emulsions may have the same Tg as Tg of either of the two emulsions.

As the above-mentioned emulsion having a high Tg, an emulsion obtainable by emulsion polymerization of a monomer component using the anionic emulsifier having a specific structure and/or the reactive emulsifier is preferably used. The above-mentioned emulsion having a low Tg is not especially limited although an emulsion obtainable by emulsion polymerization of a monomer component using the anionic emulsifier having a specific structure and/or the reactive emulsifier may be used. Commercially available items such as SBR, an acrylic emulsion, and a vinyl acetate emulsion may be used.

The above-mentioned Tg of the emulsion may be determined based on already acquired knowledge, and also may be controlled by the kind or proportion of the monomer component. However, the Tg can be calculated from the following calculation formula, theoretically,

$$\frac{1}{{Tg}^{′}} = [ \frac{{W}_{1}^{′}}{{T}_{1}} + \frac{{W}_{2}^{′}}{{T}_{2}} + … + \frac{{W}_{n}^{′}}{{T}_{n}} ]$$

in the formula, Tg′ representing a Tg (absolute temperature) of a polymer; W₁′, W₂′, and . . . Wₙ′ each representing a mass fraction of each monomer relative to the entire monomer component; and T₁, T₂, and . . . Tₙ each representing a glass transition temperature (absolute temperature) of a homopolymer of each monomer component.

It is preferable that the emulsion having the specific storage modulus value and the like of the present invention has a weight average molecular weight of 10000 to 2000000. If the weight average molecular weight is less than 10000, the vibration damping property is insufficient, and a coating material prepared using the obtained emulsion for vibration damping materials might not exhibit sufficient stability. If the weight average molecular weight is more than 2000000, the emulsion shows insufficient compatibility with, e.g., two or more different acrylic copolymers, and thereby the emulsion may fail to maintain sufficiently the balance of the vibration damping property and also may fail to improve the vibration damping property particularly in a range of 30 to 40° C. Also, the coating material prepared using such an emulsion may be insufficient in film-forming property at low temperatures when mixed with a coating material. The weight average molecular weight is preferably 30000 to 1000000, and more preferably 40000 to 250000, and still more preferably 40000 to 200000.

The weight average molecular weight can be measured by GPC (gel permeation chromatography) under the following measurement conditions.

Measurement apparatus: HLC-8120GPC (trade name, product of TOSOH CORP.)
Molecular weight column: serially connected TSK-GEL GMHXL-L and TSK-GEL G5000HXL (products of TOSOH CORP.)

### Eluent: Tetrahydrofuran (THF)

Standard substance for calibration curve: Polystyrene (product of TOSOH CORP.)
Measurement method: A measurement object is dissolved in THF such that the solid content is about 0.2% by weight, and the mixture is filtered and the filtrate as a measurement sample is measured for molecular weight.

In the above-mentioned emulsion particle having a core part and a shell part, it is preferable that a ratio by weight of the monomer component forming the core part to the monomer component forming the shell part is 20/80 to 70/30. If the ratio by weight of the monomer component forming the core part is smaller than 20/80 or larger than 70/30, the vibration damping property in a wide temperature range can not be obtained. The ratio by weight of the monomer component forming the core part to the monomer component forming the shell part is more preferably 35/65 to 55/45.

The pH of the above-mentioned emulsion is not especially limited. The pH is preferably 2 to 10, and more preferably 3 to 9, for example. The pH of the emulsion can be adjusted by adding ammonia water, water-soluble amines, alkali hydroxide aqueous solutions or the like, to the emulsion.

The pH can be measured with a pH meter (“F-23”, product of HORIBA, Ltd.).

The viscosity of the above-mentioned emulsion is not especially limited. The viscosity is preferably 10 to 10000 mPa·s and more preferably 50 to 5000 mPa·s, for example.

The viscosity can be measured under 25° C. and 20 rpm conditions with a B type rotational viscometer.

The monomer component for forming the emulsion of the present invention is not especially limited as long as it exhibits the operation and effects of the present invention. It is preferable that the monomer component contains an unsaturated carboxylic acid monomer. More preferably, the monomer component contains an unsaturated carboxylic acid monomer and other monomers copolymerizable with the unsaturated carboxylic acid monomer. The unsaturated carboxylic acid monomer is not especially limited as long as it is a compound containing an unsaturated bond and a carboxyl group in the molecule. It is preferable that the unsaturated carboxylic acid monomer contains an ethylenically unsaturated carboxylic acid monomer. That is, the preferable embodiments of the present invention include an emulsion for vibration damping material, including an emulsion obtainable by polymerizing a monomer component essentially containing an ethylenically unsaturated carboxylic acid monomer.

Further, if particles of the emulsion of the present invention are emulsion particles each having a core part and a shell part, the unsaturated carboxylic acid monomer and the other monomers copolymerizable with the unsaturated carboxylic acid monomer may be contained in either or both of the monomer component forming the core part of the emulsion and the monomer component forming the shell part of the emulsion.

The above-mentioned ethylenically unsaturated carboxylic acid monomer is not especially limited. Examples thereof include unsaturated carboxylic acids such as (meth) acrylic acid, crotonic acid, itaconic acid, fumaric acid, maleic acid, monomethyl fumarate, monoethyl fumarate, monomethyl maleate, and monoethyl maleate, and derivatives thereof. One or more species of them may be used.

Among these, an acrylic monomer is preferable. The acrylic monomer means (meth)acrylic acid and derivatives of (meth)acrylic acid such as an ester thereof.

It is preferable that the above-mentioned monomer component contains less than 10% by weight of a functional group-containing unsaturated monomer relative to the total monomer component. The functional group in the functional group-containing unsaturated monomer may be a functional group which generates cross-linkage when the emulsion is obtained by the polymerization. Due to function of such a functional group, the film-formation property or thermal drying property of the emulsion can be improved. The content of the functional group-containing unsaturated monomer is more preferably 0.1 to 3.0% by weight.

The above-mentioned content is a proportion relative to 100% by weight of the entire monomer component.

Examples of the above-mentioned functional group include an epoxy group, an oxazoline group, a carbodiimide group, an aziridinyl group, an isocyanate group, a methylol group, a vinyl ether group, a cyclocarbonate group, and an alkoxysilane group. One or more species of these functional groups may exist in one molecule of the unsaturated monomer.

Examples of the above-mentioned functional group-containing unsaturated monomer include: polyfunctional unsaturated monomers such as divinylbenzene, ethylene glycol di(meth)acrylate, N-methoxymethyl(meth)acrylamide, N-methoxyethyl(meth)acrylamide, N-n-butoxymethyl(meth)acrylamide, N-i-butoxymethyl(meth)acrylamide, N-methylol(meth)acrylamide, diallyl phthalate, diallyl terephthalate, polyethylene glycol di(meth)acrylate, propylene glycol di(meth)acrylate, polypropylene glycol di(meth)acrylate, tetramethylene glycol di(meth)acrylate, polytetramethylene glycol di(meth)acrylate, 1,6-hexanediol di(meth)acrylate, neopentyl glycol di(meth)acrylate; and glycidyl group-containing unsaturated monomers such as glycidyl (meth)acrylate and acryl glycidyl ether. Among these, an unsaturated monomer containing two or more functional groups (polyfunctional unsaturated monomer) is preferably used. These may be used singly or in combination of two or more species of them.

In the present invention, it is preferable that the above-mentioned monomer component contains 0.1 to 20% by weight of the ethylenically unsaturated carboxylic acid monomer and 99.9 to 80% by weight of the other copolymerizable ethylenically unsaturated monomers. If the monomer component includes the ethylenically unsaturated carboxylic acid monomer, the dispersibility of a filler such as inorganic powders is improved and the vibration damping property is more improved in a vibration damping composition essentially including the emulsion for vibration damping materials of the present invention. Further, if the monomer component contains other copolymerizable ethylenically unsaturated monomers, an acid value, a Tg, physical properties, and the like, of the emulsion are easily adjusted. If the content of the ethylenically unsaturated carboxylic acid monomer in the monomer component is less than 0.1% by weight or more than 20% by weight, the emulsion might not be stably produced by the copolymerization. The emulsion in the present invention can more sufficiently exhibit excellent thermal drying property and vibration damping property when used in an aqueous vibration damping material, because of a synergistic effect of monomer units derived from these monomers.

The above-mentioned content is a proportion relative to 100% by weight of the entire monomer component.

The above-mentioned other copolymerizable ethylenically unsaturated monomer is not especially limited. For example, in addition to the above-mentioned functional group-containing unsaturated monomers, one or more different (meth)acrylic esters such as methyl(meth)acrylate, ethyl(meth)acrylate, butyl(meth)acrylate, 2-ethylhexyl(meth)acrylate, and cyclohexyl(meth)acrylate. One or more different aromatic unsaturated monomers such as styrene can be used.

It is preferable that the monomer component forming the emulsion of the present invention contains 20% by weight or more of the acrylic monomer relative to 100% by weight of the entire monomer component. The monomer component more preferably contains 30% by weight or more of the acrylic monomer.

Further, the monomer component contains 40% by weight or less of an amide compound, among the above-mentioned other copolymerizable ethylenically unsaturated monomers, such as N-methoxymethyl(meth)acrylamide, N-methoxyethyl (meth)acrylamide, N-n-butoxymethyl(meth)acrylamide, and N-1-butoxymethyl(meth)acrylamide, N-methylol (meth)acrylamide, relative to 100% by weight of the entire monomer component. The monomer component more preferably contains 20% by weight or less of the amide compound.

In the present invention, it is preferable that the monomer component forming the emulsion contains one or more polymerizable monomers which form a homopolymer having a glass transition temperature of 0° C. or less. More preferably, the monomer component contains two or more species of such a polymerizable monomer. Most preferably, each monomer component used in the respective steps of multi-stage polymerization contains one polymerizable monomer which forms a homopolymer having a glass transition temperature of 0° C. or less. As the polymerizable monomer which forms a homopolymer having a glass transition temperature of 0° C. or less, ethyl acrylate, butyl acrylate, and 2-ethylhexyl acrylate are preferable. That is, in the present invention, it is preferable that the monomer component forming the emulsion particles obtainable by emulsion polymerization of the monomer component contains butyl acrylate and/or 2-ethylhexyl acrylate. If the monomer component contains butyl acrylate and/or 2-ethylhexyl acrylate, the vibration damping property in a wide temperature range can be improved.

More preferably, the monomer component includes butyl acrylate and 2-ethylhexyl acrylate.

If the above-mentioned monomer component includes butyl acrylate, it is preferable that the content of the butyl acrylate is 10 to 60% by weight relative to 100% by weight of the monomer component forming the acrylic copolymer. The content is more preferably 20 to 50% by weight.

If the above-mentioned monomer component includes 2-ethylhexyl acrylate, it is preferable that the content of the 2-ethylhexyl acrylate is 5 to 55% by weight relative to 100% by weight of the monomer component forming the acrylic copolymer. The content is more preferably 10 to 50% by weight.

If the above-mentioned monomer component contains both of butyl acrylate and 2-ethylhexyl acrylate, it is preferable that the total content of the butyl acrylate and 2-ethyhexyl acrylate is 20 to 70% by weight relative to 100% by weight of the monomer component forming the acrylic copolymer. The total content is more preferably 30 to 60% by weight.

The emulsion for vibration damping materials of the present invention is obtainable by emulsion polymerization of the monomer component, and the emulsion may be a mixture of the emulsion having the specific storage modulus value and the like with other emulsion resins. Also in this case, the same operation and effects as in the present invention can be obtained. Preferred examples of other emulsion resins include acrylic resin, urethane resin, SBR resin, epoxy resin, vinyl acetate resin, vinyl acetate-acrylic resin, vinyl chloride resin, vinyl chloride-acrylic resin, vinyl chloride-ethylene resin, vinylidene chloride resin, styrene-butadiene resin, acrylonitrile-butadiene resin. One or more species of them may be used.

In this case, it is preferable that a ratio by weight of the emulsion having the specific storage modulus value and the like to the other emulsion resins (the emulsion having the specific storage modulus value/the other emulsion resins) is 100 to 50/0 to 50.

With regard to a production method of the emulsion of the present invention, the monomer component is polymerized by an emulsion polymerization method in the presence of an emulsifier. The embodiment of the emulsion polymerization is not especially limited. For example, the emulsion polymerization can be performed by appropriately adding the monomer component, a polymerization initiator, and an emulsifier in an aqueous medium. It is preferable that a polymerization chain transfer agent and the like is used to adjust the molecular weight.

As mentioned above, the reactive emulsifier and/or the anionic emulsifier having a specific structure can be preferably used as the emulsifier, but other anionic surfactants, nonionic surfactants, cationic surfactants, amphoteric surfactants, and polymer surfactants, each of which is commonly used for the emulsion polymerization, may be used. One or more species of them may be used.

It is preferable that if the emulsion of the present invention is an emulsion having a core part and a shell part, the emulsion is obtainable by a common emulsion polymerization method. Specifically, it is preferable that the emulsion is obtainable by the following multi-stage polymerization: the monomer component is subjected to emulsion polymerization in an aqueous medium in the presence of an emulsifier and/or a protective colloid, thereby forming a core part; and then the monomer component is further polymerized with the emulsion having a core part through emulsion polymerization, thereby forming a shell part. Thus, the preferable embodiments of the present invention include an embodiment in which the emulsion of the present invention is an emulsion having a core part and a shell part, and the emulsion is obtainable by multi-stage polymerization in which the core part is formed and then the shell part is formed. If the emulsion having a core part and a shell part is produced, a method in which a core part is formed, and then a monomer component forming a shell part is added to form a shell part is preferable.

The above-mentioned aqueous medium is not especially limited. Examples thereof include water, a mixture solvent composed of one or more water-miscible solvents, or a mixture solvent containing water as a main component and such solvents. Among these, water is preferably used.

The above-mentioned anionic surfactant which is commonly used for the emulsion polymerization other than the anionic emulsifier having a specific structure is not especially limited. Examples thereof include alkyl sulfates such as sodium dodecyl sulfate, potassium dodecyl sulfate, and ammonium alkyl sulfate; sodium dodecyl polyglycol ether sulfate; sodium sulforicinoate; alkyl sulfonates such as sulfonated paraffin salt; alkyl sulfonates such as sodium dodecylbenzene sulfonate, and alkali metal sulfates of alkali phenol hydroxyethylene; higher alkyl naphthalene sulfonates; naphthalene sulfonate-formalin condensates; fatty acid salts such as sodium laurate, triethanol amine oleate, and triethanol amine abietate; polyoxyalkyl ether sulfates; polyoxyethylene carboxylic acid ester sulfates; polyoxyethylene phenyl ether sulfates; succinic acid dialkyl ester sulfonates; and polyoxyethylene alkylaryl sulfates. One or more species of them may be preferably used.

The above-mentioned nonionic surfactant which is commonly used for the emulsion polymerization other than the reactive emulsifier is not especially limited. Examples thereof include: polyoxyethylene alkyl ether; polyoxyethylene alkyl aryl ether; sorbitan aliphatic ester; polyoxyethylene sorbitan aliphatic ester; aliphatic monoglycerides such as glycerol monolaurate; polyoxyethylene-oxypropylene copolymer; and a condensation product of ethylene oxide with aliphatic amine, amide, or acid. One or more species of them may be used.

The above-mentioned cationic surfactant which is commonly used for the emulsion polymerization other than the reactive emulsifier is not especially limited. Examples thereof include: dialkyl dimethyl ammonium salts, ester dialkyl ammonium salts, amide dialkyl ammonium salts, and dialkyl imidazolium salts. One or more species of them may be preferably used.

The above-mentioned amphoteric surfactant which is commonly used for the emulsion polymerization other than the reactive emulsifier is not especially limited. Examples thereof include: betaine alkyldimethyl aminoacetate, alkyl dimethyl amine oxide, alkyl carboxymethyl hydroxyethyl imidazolinium betaine, alkyl amide propyl betaine, and alkyl hydroxy sulfobetaine. One or more species of them may be preferably used.

The above-mentioned polymer surfactant which is commonly used for the emulsion polymerization other than the reactive emulsifier is not especially limited. Examples thereof include: polyvinyl alcohols and modified products thereof; (meth)acrylic water-soluble polymers; hydroxyethyl (meth)acrylic water-soluble polymers; hydroxypropyl (meth)acrylic water-soluble polymers; and polyvinyl pyrrolidone. One or more species of them may be preferably used.

Among the above-mentioned surfactants, non-nonylphenyl surfactants are preferably used in view of environment.

The use amount of the above-mentioned surfactant may be appropriately determined depending on the kind of the used surfactant or the kind of the used monomer component. For example, the use amount of the surfactant is preferably 0.3 to 10 parts by weight, and more preferably 0.5 to 5 parts by weight, relative to 100 parts by weight of the total amount of the monomer component used for forming the emulsion.

Examples of the above-mentioned protective colloid include polyvinyl alcohols such as partially saponified polyvinyl alcohols, completely saponified polyvinyl alcohols, and modified polyvinyl alcohols; cellulose derivatives such as hydroxyethyl cellulose, hydroxypropylcellulose, and carboxymethylcellulose salt; natural polysaccharides such as Guar gum. One or more species of them may be used. Such a protective colloid may be used singly or in combination with the surfactant.

The use amount of the above-mentioned protective colloid may be appropriately determined depending on use conditions. For example, it is preferably 5 parts by weight or less, and more preferably 3 parts by weight or less, relative to 100 parts by weight of the total amount of the monomer component used for preparing the emulsion.

The above-mentioned polymerization initiator is not especially limited as long as it is a substance which is decomposed by heating and generates radical molecules. Water-soluble initiators are preferably used. Examples of such an initiator include persulfates such as potassium persulfate, ammonium persulfate, and sodium persulfate; water-soluble azo compounds such as 2,2′-azobis(2-amidinopropane) dihydrochloride and 4,4′-azobis(4-cyanopentanoic acid); thermal decomposition initiators such as hydrogen peroxide; and redox polymerization initiators such as hydrogen peroxide and ascorbic acid, t-butyl hydroperoxide and rongalite, potassium persulfate and metal salt, and ammonium persulfate and sodium hydrogen sulfite. One or more species of them may be used.

The use amount of the above-mentioned polymerization initiator is not especially limited and may be appropriately determined depending on the kind of the polymerization initiator, and the like. For example, the use amount of the polymerization initiator is preferably 0.1 to 2 parts by weight and more preferably 0.2 to 1 part by weight, relative to 100 parts by weight of the total amount of the monomer component used for preparing the emulsion.

A reducing agent may be used in combination with the above-mentioned polymerization initiator, if needed, in order to accelerate the emulsion polymerization. Examples of the reducing agent include reducing organic compounds such as ascorbic acid, tartaric acid, citric acid, and glucose; and reducing inorganic compounds such as sodium thiosulfate, sodium sulfite, sodium bisulfite, and sodium metabisulfite. One or more species of them may be used.

The use amount of the above-mentioned reducing agent is not especially limited and preferably 0.05 to 1 part by weight, relative to 100 parts by weight of the total amount of the monomer component used for preparing the emulsion, for example.

The above-mentioned polymerization chain transfer agent is not especially limited. Examples of the above-mentioned polymerization chain transfer agent include alkyl mercaptans such as hexyl mercaptan, octyl mercaptan, n-dodecyl mercaptan, t-dodecyl mercaptan, n-hexadecyl mercaptan, and n-tetradecyl mercaptan; halogenated hydrocarbons such as carbon tetrachloride, carbon tetrabromide, and ethylene bromide; mercaptocarboxylic acid alkyl esters such as 2-ethylhexyl mercaptoacetate, 2-ethylhexyl mercaptopropionate, and tridecyl mercaptopropionate; mercaptocarboxylic acid alkoxyalkyl esters such as methoxybutyl mercaptoacetate and methoxybutyl mercaptopropionate; carboxylic acid mercaptoalkyl esters such as 2-mercaptoethyl octanoate; α-methylstyrene dimer, terpinolene, α-terpinene, γ-terpinene, dipentene, anisole, and allyl alcohol. These may be used singly or in combination of two or more species of them. Among these, it is preferable to use an alkylmercaptan such as hexylmercaptan, octylmercaptan, n-dodecylmercaptan, t-dodecylmercaptan, n-hexadecylmercaptan, n-tetradecylmercaptan or the like. The use amount of the polymerization chain transfer agent is generally 2.0 parts by weight or less, and preferably 1.0 part by weight or less relative to 100 parts by weight of the entire monomer component, for example.

If necessary, the above-mentioned emulsion polymerization may be performed in the presence of a chelating agent such as sodium ethylenediaminetetraacetate, a dispersant such as sodium polyacrylate, or an inorganic salt. With regard to the addition method of the monomer component, the polymerization initiator, and the like, any of en bloc addition, continuous addition, multi-stage addition and the like may be employed. These addition methods may be used in a suitable combination.

Regarding the emulsion polymerization conditions in the above-mentioned production method, the polymerization temperature is not especially limited and preferably 0 to 100° C. and more preferably 40 to 95° C., for example. The polymerization time is not especially limited, and preferably 1 to 15 hours, and more preferably 5 to 10 hours, for example.

The addition method of the monomer component, the polymerization initiator, and the like, is not especially limited, and any of en bloc addition, continuous addition, multi-stage addition and the like may be employed, for example. These addition methods may be used in a suitable combination.

In the production method of the emulsion of the present invention, it is preferable that the emulsion is produced by emulsion polymerization and then the emulsion is neutralized with a neutralizer. As a result, the emulsion is stabilized. The neutralizer is not especially limited. Examples thereof include tertiary amines such as triethanolamine, dimethylethanolamine, diethylethanolamine, morpholine; ammonia water; and sodium hydroxide. These may be used singly or in combination of two or more species of them. Among these, volatile bases which evaporate from the coating film at the time of heating are preferably used because the water resistance and the like is improved in the coating film formed from a vibration damping composition essentially containing the emulsion for vibration damping materials. More preferably, an amine having a boiling point of 80 to 360° C. is used because the thermal drying property becomes excellent and the vibration damping property is improved. As such a neutralizer, tertiary amines such as triethanolamine, dimethylethanolamine, diethylethanolamine, and morpholine are preferred, for example. More preferably, an amine having a boiling point of 130 to 280° C. is employed.

The above-mentioned boiling point is a boiling point under atmospheric pressure.

The addition amount of the above-mentioned neutralizer is not especially limited, and it is preferably determined in such a way that a base of the neutralizer accounts for 0.6 to 1.4 equivalents relative to an acid value of the emulsion, that is, one equivalent of an acid group contained in the emulsion. It is more preferable that the base of the neutralizer accounts for 0.8 to 1.2 equivalents.

If the number average molecular weight of the above-mentioned emulsion is small, the compatibility of a filler such as inorganic powders with the emulsion is improved and therefore the dispersibility is improved in the vibration damping composition including the emulsion for vibration damping materials of the present invention essentially containing the emulsion.

The emulsion for vibration damping materials of the present invention can constitute a vibration damping composition, if needed, in combination with other components. The present invention also includes a vibration damping composition essentially including such an emulsion for vibration damping materials of the present invention as one preferable embodiment of the present invention. Such a composition can form an aqueous vibration damping material which can exhibit excellent thermal drying property and vibration damping property.

It is preferable that the above-mentioned vibration damping composition contains 50 to 90% by weight of a solid content relative to 100% by weight of the total amount of the vibration damping composition. The solid content is more preferably 60 to 90% by weight and still more preferably 70 to 90% by weight. The pH of the vibration damping composition is preferably 7 to 11. More preferably, the pH is 7 to 9.

It is preferable that the content of the emulsion for vibration damping materials in the above-mentioned vibration damping composition is determined in such a way that the solid content of the emulsion for vibration damping materials is 10 to 60% by weight relative to 100% by weight of the solid content of the vibration damping composition. The solid content is more preferably 15 to 55% by weight.

The vibration damping property of the above-mentioned vibration damping composition can be evaluated by measuring a loss coefficient of a coating film formed using the vibration damping composition. The loss coefficient is generally represented by η, and it is the most general index expressing vibration damping performances. Also in the present invention, the loss coefficient is preferably used for evaluating the vibration damping performances. The higher loss coefficient the coating film shows, the more excellent vibration damping performances the coating film has. Further, it is preferable that the composition is influenced by a temperature and exhibits high vibration damping performances within a practical temperature range. In the present invention, for example, the practical temperature range of the coating film formed using the vibration damping composition is generally 20 to 60° C. It is preferable that the coating film has a loss coefficient of 0.10 or more at 40° C. More preferably, the coating film has a loss coefficient of 0.12 or more at 40° C. Further, the vibration damping performances can be evaluated based on the total loss coefficients at 20° C., 40° C., and 60° C. That is, the higher the total loss coefficients at 20° C., 40° C., and 60° C. is, the more excellent practical vibration damping performances the coating film has. Thus, the loss coefficient is useful as one index for evaluating the vibration damping property. The preferable range of the total loss coefficients at 20° C., 40° C., and 60° C. is 0.20 or more. According to this invention, the total loss coefficients can absolutely satisfy this value, According to one of the advantageous effects of the present invention, as mentioned above, the emulsion is excellent in the mechanical stability, the surface state of the dried coating film, the resistance to coating film collapsibility (coating film collapsibility after baking) and further, the emulsion can exhibit excellent vibration damping performances in the wide practical temperature range. That is, the emulsion is excellent in these performances. According to the present invention, it is preferably that the above-mentioned total loss coefficients at 20° C., 40° C., and 60° C. satisfy 0.22 or more. The total loss coefficients more preferably satisfy 0.24 or more.

With regard to the measurement method of the above-mentioned loss coefficients, a resonance method in which the measurement is performed around at a resonant frequency is common, and further, a half value method, an attenuation factor method, and a mechanical impedance method may be mentioned. According to the vibration damping composition of the present invention, the loss coefficient of the coating film formed using the vibration damping composition is preferably measured as follows. That is, the vibration damping composition is coated on a cold rolling steel plate (SPCC: 15 mm in width×250 mm in length×1.5 mm in thickness) to form a coating film having a surface density of 4.0 kg/m². The coating film is measured for a loss coefficient by a 3 dB method using a cantilever method (product of ONO SOKKI CO., LTD., loss coefficient measurement system).

Examples of the above-mentioned other components include solvent; plasticizer; stabilizer; thickener; wetting agent; antiseptic; foaming inhibitor; filler; coloring agent; dispersant; antirust pigment; defoaming agent; antioxidant; mildew-proofing agent; ultraviolet absorber; and antistatic agent. One or more species of them may be used. Among these, it is preferable that the vibration damping composition includes a filler. It is preferable that the vibration damping composition includes a pigment (a colorant or an antirust pigment).

The above-mentioned other components can be mixed with the above-mentioned emulsion for vibration damping materials and the like using, for example, a butterfly mixer, a planetary mixer, a spiral mixer, kneader, and a dissolver.

Examples of the above-mentioned solvent include ethylene glycol, butyl cellosolve, butyl carbitol, and butyl carbitol acetate. The mixing amount of the solvent may be appropriately determined such that the concentration of the solid content of the emulsion for vibration damping materials in the vibration damping composition is within the above-mentioned range.

Polyvinyl alcohols, cellulose derivatives, and polycarboxylic acid resins may be mentioned as the above-mentioned thickener, for example. With regard to the mixing amount of the thickener, the thickener is preferably 0.01 to 2 parts by weight on the solid content equivalent basis relative to 100 parts by weight of the solid content of the emulsion for vibration damping materials, and it is more preferably 0.05 to 1.5 parts by weight, and still more preferably 0.1 to 1 part by weight.

Examples of the above-mentioned filler include inorganic fillers such as calcium carbonate, kaolin, silica, talc, barium sulfate, alumina, iron oxide, titanium oxide, glass powders, magnesium carbonate, aluminum hydroxide, talc, kieselguhr, and clay; scale-like inorganic fillers such as glass flakes and mica; and filamentous inorganic fillers such as metal oxide whiskers, glass fibers. The mixing amount of the above-mentioned inorganic filler is preferably 50 to 700 parts by weight, relative to 100 parts by weight of the solid content of the emulsion for vibration damping materials, for example. The mixing amount of the inorganic filler is more preferably 100 to 550 parts by weight.

Organic or inorganic coloring agents such as titanium oxide, carbon black, red iron oxide, Hansa yellow, benzine yellow, copper phthalocyanine blue, and quinacridone red may be mentioned as the above-mentioned coloring agent, for example.

Inorganic dispersants such as sodium hexametaphosphate and sodium tripolyphosphate and organic dispersants such as polycarboxylic acid dispersants may be mentioned as the above-mentioned dispersant, for example.

Metal salts of phosphoric acid, metal salts of molybdic acid, and metal salts of boric acid may be mentioned as the above-mentioned antirust pigment, for example.

Silicone antifoaming agents may be mentioned as the above-mentioned antifoaming agent, for example.

A foaming agent is preferably used as the above-mentioned other components. In this case, it is preferable that the above-mentioned vibration damping composition is dried by heating to form a vibration damping coating film, as mentioned below. If the above-mentioned emulsion for vibration damping materials is further mixed with a foaming agent, the vibration damping material has a uniform foaming structure and it can be formed to have a larger thickness, and thereby sufficient thermal drying property and high vibration damping property are exhibited. Thus, the preferable embodiments of the present invention include a vibration damping composition containing the emulsion for vibration damping materials of the present invention and a foaming agent. The vibration damping composition may further contain other components, if needed.

The above-mentioned foaming agent is not especially limited. Preferable examples thereof include low-boiling hydrocarbon-containing thermal expansion microcapsules, organic foaming agents, and inorganic foaming agents. One or more species of them may be used. Examples of the thermal expansion microcapsules include Matsumoto Microsphere F-30, F-50 (products of Matsumoto Yushi-Seiyaku Co., Ltd.); and EXPANCEL WU642, WU551, WU461, DU551, DU401 (products of Japan Expancel Co., Ltd.). Examples of the organic foaming agent include azodicarbonamide, azobisisobutyronitrile, N,N-dinitrosopentamethylenetetramine, p-toluenesulfonylhydrazine, and p-oxybis(benzenesulfohydrazide). Examples of the inorganic foaming agent include sodium bicarbonate, ammonium carbonate, and silicon hydride.

The mixing amount of the above-mentioned foaming agent is preferably 0.5 to 5.0 parts by weight, relative to 100 parts by weight of the emulsion for vibration damping materials, for example. The mixing amount of the foaming agent is more preferably 1.0 to 3.0 parts by weight.

It is also preferable that the above-mentioned vibration damping composition further containing the foaming agent further contains an inorganic pigment. In such a case, the composition can more sufficiently exhibit the above-mentioned thermal drying property and high vibration damping property.

The above-mentioned inorganic pigment is not especially limited, and one or more species of the above-mentioned inorganic coloring agents or inorganic antirust pigments may be used, for example.

The mixing amount of the above-mentioned inorganic pigment is preferably 50 to 700 parts by weight, relative to 100 parts by weight of the emulsion for vibration damping materials. More preferably, the mixing amount of the inorganic pigment is 100 to 550 parts by weight.

As the above-mentioned other components, a polyvalent metal compound also may be used. In this case, the polyvalent metal compound improves the stability, dispersibility, thermal drying property of the vibration damping composition, and the vibration damping property of the vibration damping material formed using the vibration damping composition. The polyvalent metal compound is not especially limited. Examples thereof include zinc oxide, zinc chloride, and zinc sulfate. One or more species of them may be used.

The form of the above-mentioned polyvalent metal compound is not especially limited, and it may be in the form of a powder, an aqueous dispersion, an emulsified dispersion, or the like. Among these, the polyvalent metal compound is preferably used in the form of an aqueous dispersion or an emulsified dispersion, and more preferably in the form of an emulsified dispersion because the dispersibility in the vibration damping composition is improved. With regard to the use amount of the polyvalent metal compound, the polyvalent metal compound is preferably 0.05 to 5.0 parts by weight relative to 100 parts by weight of the solid content in the vibration damping composition, and it is more preferably 0.05 to 3.5 parts by weight.

The above-mentioned vibration damping composition is applied on a substrate and dried to give a coating film serving as a vibration damping material. The substrate is not especially limited. With regard to the method of coating the substrate with the vibration damping composition, brush, spatula, air spray gun, airless spray gun, mortar gun, texture gun, and the like, may be used for coating.

The coating amount of the above-mentioned vibration damping composition may be appropriately determined depending on the intended application, desired performance, and the like. The coating film after drying preferably has a thickness of 0.5 to 8.0 mm, and more preferably 3.0 to 6.0 mm.

It is also preferable that the coating film after drying has a surface density of 1.0 to 7.0 kg/m². The surface density is more preferably 2.0 to 6.0 kg/m². Use of the vibration damping composition of the present invention makes it possible to obtain a coating film which hardly generates blisters or cracks at the time of drying and hardly sags on the inclined surface.

Thus, a method of coating the vibration damping composition in such a way that the coating film after drying has a thickness of 0.5 to 8.0 mm and then dried or a method of coating the vibration damping composition in such a way that the coating film after drying has a surface density of 2.0 to 6.0 kg/m² and then dried are included in the preferable embodiments of the present invention. The preferable embodiments of the present invention also include a vibration damping material obtainable by the above-mentioned method of coating the vibration damping composition.

Regarding the conditions when the coating film is formed by coating and drying the above-mentioned vibration damping composition, the coated vibration damping composition may be dried by heating or at atmospheric temperature. The vibration damping composition in the present invention is excellent in thermal drying property. Therefore, in view of efficiency, it is preferable that the vibration damping composition is dried by heating. The temperature at which the composition is dried by heating is preferably 80 to 210, and more preferably 110 to 180° C., and still more preferably 120 to 170° C.

The aqueous resin composition for coating materials of the present invention has the above-mentioned configuration. Such an aqueous resin composition contains the following emulsion for vibration damping materials. The emulsion for vibration damping materials is excellent in vibration damping property in a wide temperature range, and mechanical stability. Further, such an emulsion for vibration damping materials can be preferably used, as a raw material for vibration damping coating materials, beneath cabin floors of automobiles and so applied to rolling stock, ships, aircraft, electricmachines, buildings, and construction machines, among other applications.

### BEST MODE FOR CARRYING OUT THE INVENTION

The present invention is described in more detail with reference to Examples below, but the present invention is not limited to only these Examples. The terms, “part (s)” and “%” represent “part (s) by weight” and “% by weight”, respectively, unless otherwise specified.

Various physical properties and the like are evaluated as follows in the following Examples.

### “Tg”

Based on the constitutional components and the proportions thereof in the monomer component at each stage, the Tg was calculated from the above-mentioned Fox formula. The Tg calculated based on the constitutional components and the proportions thereof in the monomer component at all stages was described as a “total Tg.”

The Tg value of each homopolymer which was used to calculate the glass transition temperature (Tg) of the polymerizable monomer component from the Fox formula was shown below.

If a cross-linking monomer is used, the calculation Tg was calculated with the exception for the cross-linking monomer.

### Styrene (St): 100° C.

Methyl methacrylate (MMA): 105° C.
2-ethylhexyl acrylate (2EHA): −70° C.
Acrylic acid (AA): 9500
N-butyl methacrylate (n-BMA): 2000
Butyl acrylate (BA): −56° C.

### “Nonvolatile Content (NV)”

The obtained aqueous resin dispersant about 1 g was weighed and dried in a hot air dryer at 110° C. for 1 hour. Then, the residue amount after drying was measured as a nonvolatile content and expressed as % by weight relative to the weight before drying.

“pH”

The pH value at 25° C. was measured using a pH meter (“F-23”, product of HORIBA, Ltd.).

### “Viscosity”

The viscosity was measured at 25° C. and 20 rpm using a B type rotary viscometer.

### “Minimum Film-Formation Temperature (MFT)”

The obtained aqueous resin dispersant was coated on a glass plate placed on a heat gradient test apparatus using an applicator which gives a 0.2 mm thick film. Then, the coated film was dried and measured for a temperature when cracks were generated on the coating film. The temperature was defined as a minimum film-formation temperature (MFT).

### “Weight Average Molecular Weight”

The weight average molecular weight was measured by GPC (gel permeation chromatography) under the following measurement conditions.

Measurement apparatus: HLC-8120 GPC (tradename, product of TOSOH CORP.)
Molecular weight column: serially connected TSK-GEL GMHXL-L and TSK-GEL G5000HXL (products of TOSOH CORP.)

### Eluent: Tetrahydrofuran (THF)

Standard substance for calibration curve: Polystyrene (product of TOSOH CORP.)
Measurement method: A measurement object was dissolved in THF such that the solid content accounts for about 0.2% by weight, and the mixture was filtered and the filtrate as a measurement sample was measured for molecular weight.

### “Mechanical Stability”

Purified water 30 g was added to the vibration damping composition 100 g and the mixture was stirred and mixed enough. The mixture was filtered through a 100 metal mesh. Then, the filtered mixture 70 g was subjected to mechanical stability test using a Maron stability tester (produced by KUMAGAI RIKI KOGYO CO., LTD.) (according to JIS K6828:1996, platform scale 10 kg, disk rotation frequency 1000 min-1, rotation time 5 minutes, test temperature 25° C.). Immediately after the test, the vibration damping composition was filtered through a 100 metal mesh, and dried in an oven at 110° C. for 1 hour. The aggregation ratio of the vibration damping composition was calculated from the following formula and evaluated.

Aggregation ratio (%)=(weight (g) of metal mesh after drying−weight (g) of metal mesh before drying)/70 (g)×100

### Evaluation Standards

Excellent: less than 0.0001%
Good: 0.0001% or more and less than 0.001%
Average: 0.001% or more and less than 0.01%
Poor: 0.01% or more and less than 0.1%

### “Dynamic Mechanical Analysis”

The emulsion for vibration damping materials was applied on a teflon sheet to have a thickness of 0.1 mm after being dried. Then, the applied emulsion was cured for 30 minutes at a room temperature, and further dried for 30 minutes at 90° C. and for 30 minutes at 130° C. to give a film specimen. This film specimen was subjected to dynamic mechanical analysis with a strain controlled solid dynamic mechanical analysis instrument, RSA-III (product of TA Instruments, Inc.) under the following conditions.

Sample size: 5 to 25 mm

### Frequency: 1 Hz

Load strain: 0.1%
Rate of temperature increase: 3° C./min
Measurement temperature: −40 to 100° C.

As a result, the emulsion was determined for a dynamic storage modulus (E*), a dynamic loss modulus (E**), and the maximum value of a loss tangent (or the local maximum value: tan δ MAX).

### “Vibration Damping Property Test”

The above-mentioned vibration damping composition was coated on a cold rolling steel plate (SPCC: 15 in width×250 in length×1.5 mm in thickness) to have a thickness of 3 mm. The coated composition was dried at 150° C. for 30 minutes. As a result, a vibration damping coating film having a surface density of 4.0 kg/m² was formed on the cold rolling steel plate. The coating film was measured for vibration damping property as follows: the loss coefficient at the respective temperatures (20° C. to 60° C.) were measured by a resonance method (3 dB method) using a cantilever method (product of ONO SOKKI CO., LTD., loss coefficient measurement system).

### EXAMPLE 1

A polymerization vessel equipped with a stirrer, a reflux condenser, a thermometer, a nitrogen inlet tube and a dropping funnel was filled with deionized water 339 parts. Then, the internal temperature was increased to 75° C. under stirring and nitrogen flow. The above-mentioned dropping funnel was filled with a monomer emulsion composed of styrene 635.0 parts, 2-ethylhexyl acrylate 350.0 parts, trimethylolpropane trimethacrylate 5.0 parts, acrylic acid 15.0 parts, t-dodecylmercaptan 3.0 parts, a previously adjusted 20% aqueous solution of NEWCOL 707SF (trade name, polyoxyethylene polycyclic phenyl ether ammonium sulfate, product of Nippon Nyukazai Co., Ltd.) 180.0 parts and deionized water 164.0 parts. While the internal temperature of the polymerization vessel was maintained at 80° C., the above-mentioned monomer emulsion, a 5% aqueous solution of potassium persulfate 100 parts and a 2% aqueous solution of sodium hydrogen sulfite 100 parts were uniformly added dropwise for 210 minutes.

The obtained reaction liquid was cooled to a room temperature, and then thereinto, 2-dimethylethanolamine 16.7 parts was added. As a result, an emulsion for vibration damping materials 1 was prepared. The obtained aqueous resin dispersant was measured for solid content, pH, viscosity, MFT, and weight average molecular weight by the above-mentioned methods, respectively. The kind and amount of each of the used polymerizable monomers are expressed by a proportion (parts by weight) relative to the total amount of the polymerizable monomers which were used in the both stages in Table 1.

The measurement results obtained in Examples 2 to 11 and Comparative Examples 1 to 4 are also shown in Tables 1 to 3.

### EXAMPLE 2, COMPARATIVE EXAMPLES 1, AND 5 to 7

An emulsion for vibration damping materials 2, and comparative emulsions for vibration damping materials 1, and 5 to 7 were prepared in the same manner as in Example 1, except that the constitutional components and the proportions thereof in the aqueous resin in Example 1 were changed to those shown in Tables 1 to 3.

The comparative emulsion for vibration damping materials 1 was insufficient in polymerization stability and therefore it could not provide an aqueous resin dispersant. Therefore, the various characteristics values in Tables 1 to 3 could not be measured.

### EXAMPLE 3

A polymerization vessel equipped with a stirrer, a reflux condenser, a thermometer, a nitrogen inlet tube and a dropping funnel was filled with deionized water 339 parts. Then, the internal temperature was increased to 75° C. under stirring and nitrogen flow. The above-mentioned dropping funnel was filled with a monomer emulsion used in the reaction at the first stage, composed of styrene 100.0 parts, 2-ethylhexyl acrylate 80.0 parts, butyl acrylate 130.0 parts, methyl methacrylate 150.0 parts, acrylic acid 5.0 parts, methacrylic acid 30.0 parts, t-dodecylmercaptan 2.0 parts, a previously adjusted 20% aqueous solution of LATEMUL WX (trade name, polyoxyethylene oleyl ether sulfate, product of Kao Corp.) 72.0 parts and deionized water 66.0 parts. While the internal temperature of the polymerization vessel was maintained at 80° C., the above-mentioned monomer emulsion, a 5% aqueous solution of potassium persulfate 40 parts and a 2% aqueous solution of sodium hydrogen sulfite 40 parts were uniformly added dropwise for 90 minutes. Thus, the polymerization reaction at the first stage was completed.

Successively, a monomer emulsion used in the reaction at the second stage, composed of 2-ethylhexyl acrylate 100.0 parts, styrene 100.0 parts, butyl acrylate 175.0 parts, methyl methacrylate 120.0 parts, acrylic acid 10.0 parts, t-dodecylmercaptan 2.0 parts, a previously adjusted 20% aqueous solution of NEWCOL 707SN (tradename, polyoxyethylenealkyl ether sulfate, product of Nippon Nyukazai Co., Ltd.) 108.0 parts, and deionized water 98.0 parts was uniformly added dropwise at 80° C. for 120 minutes. Simultaneously, a 5% aqueous solution of potassium persulfate 60 parts and a 2% aqueous solution of sodium hydrogen sulfite 60 parts were uniformly added dropwise for 120 minutes. After completion of the dropwise addition, the temperature was maintained for 60 minutes, and thereby the polymerization reaction at the second stage was completed.

The obtained reaction liquid was cooled to a room temperature, and thereto, 2-dimethylethanolamine 16.7 parts was added. As a result, an emulsion for vibration damping materials 3 was obtained.

### EXAMPLES 4 TO 9, 12, AND COMPARATIVE EXAMPLES 2 TO 4

Emulsions for vibration damping materials 4 to 9, 12, and comparative emulsions for vibration damping materials 2 to 4 were prepared in the same manner as in Example 3, except that the constitutional components and the proportions thereof in the aqueous resin in Example 3 were changed to those shown in Tables 1 to 3.

### EXAMPLE 10

An emulsion for vibration damping materials was obtained by adding 105 parts of EPOCROS WS-500 into the aqueous resin dispersant obtained in Example 9.

### EXAMPLE 11

An emulsion for vibration damping materials 11 was obtained in the same manner as in Example 1, except that the constitutional components and the proportions thereof in the aqueous resin in Example 1 were changed to those shown in Table 2.

### Preparation of Vibration Damping Composition

Vibration damping compositions were prepared using the emulsions for vibration damping materials obtained in Examples 1 to 12 and Comparative Examples 1 to 7 at the following proportions, and evaluated for mechanical stability, and vibration damping property. Tables 1 to 3 show the results.

| | | |
|---|---|---|
| Acrylic copolymer emulsion | 359 | parts |
| Calcium carbonate NN#200*¹ | 620 | parts |
| Dispersant AQUALIC DL-40S*² | 6 | parts |
| Thickener ACRYSET WR-650*³ | 4 | parts |
| Defoaming agent NOPCO 8034L*⁴ | 1 | part |
| Foaming agent F-30*⁵ | 6 | parts |

*¹filler, product of NITTO FUNKA KOGYO K.K.
*²polycarboxylic acid polymeric dispersant (active component 44%), product of NIPPON SHOKUBAI CO., LTD.
*³alkali-soluble acrylic thickener (active component 30%), product of NIPPON SHOKUBAI CO., LTD.
*⁴defoaming agent (main component: hydrophobic silicon + mineral oil), product of SAN NOPCO, Ltd.
*⁵foaming agent, product of Matsumoto Yushi-Seiyaku Co., Ltd.

TABLE 1

| | | | Example | | | | | |
|---|---|---|---|---|---|---|---|---|
| | | | 1 | 2 | 3 | 4 | 5 | 6 |
| 1 st stage | 2EHA | | 35.0 | 35.0 | 8.0 | 13.5 | 13.5 | 13.5 |
| (unit: part) | St | | 63.5 | 64.0 | 10.0 | 27.5 | 17.0 | 27.5 |
| | MMA | | — | — | 15.0 | — | 14.0 | — |
| | BA | | — | — | 13.0 | — | — | — |
| | TMPTMA | | 0.5 | — | — | — | — | — |
| | AA | | 1.5 | 1.0 | 0.5 | 0.5 | — | 0.5 |
| | MAA | | — | — | 3.0 | — | 1.0 | — |
| | n-BMA | | — | — | — | — | — | — |
| | t-DM | | 0.3 | 0.4 | 0.2 | 0.2 | 0.2 | 0.2 |
| | Total | | 100.8 | 100.4 | 49.7 | 41.7 | 45.7 | 41.7 |
| 2 nd stage | 2EHA | | — | — | 10.0 | — | 5.0 | — |
| (unit: part) | St | | — | — | 10.0 | 23.0 | 17.5 | 23.0 |
| | MMA | | — | — | 12.0 | — | 6.0 | — |
| | BA | | — | — | 17.5 | 35.0 | 25.0 | 35.0 |
| | AA | | — | — | 1.0 | 0.5 | — | 0.5 |
| | MAA | | — | — | — | — | 1.0 | — |
| | n-BMA | | — | — | — | — | — | — |
| | t-DM | | — | — | 0.2 | 0.2 | 0.2 | 0.2 |
| | Total | | 0.0 | 0.0 | 50.7 | 58.7 | 54.7 | 58.7 |
| 1 st stage, | 2EHA | | 35.0 | 35.0 | 18.0 | 13.5 | 18.5 | 13.5 |
| 2 nd stage | St | | 63.5 | 64.0 | 20.0 | 50.5 | 34.5 | 50.5 |
| Total | MMA | | — | — | 27.0 | — | 20.0 | — |
| (unit: part) | BA | | — | — | 30.5 | 35.0 | 25.0 | 35.0 |
| | TMPTMA | | 0.5 | — | — | — | — | — |
| | AA | | 1.5 | 1.0 | 1.5 | 1.0 | — | 1.0 |
| | MAA | | — | — | 3.0 | — | 2.0 | — |
| | n-BMA | | — | — | — | — | — | — |
| | t-DM | | 0.3 | 0.4 | 0.4 | 0.4 | 0.4 | 0.4 |
| | Subtotal | | 100.8 | 100.4 | 100.4 | 100.4 | 100.4 | 100.4 |
| | Used emulsifier | | A | B | C | C | A | C + D |
| Calculation | 1 st stage Tg | | 15 | 15 | 10 | 20 | 27 | 20 |
| Tg | 2 nd stage Tg | | — | — | −9 | −12 | −7 | −12 |
| | Total Tg | | 15 | 15 | 0 | 0 | 9 | 0 |
| | Δ Tg | | — | — | 19 | 32 | 34 | 32 |
| Characteristic | NV(%) | | 54.5 | 54.6 | 54.7 | 54.8 | 54.9 | 54.9 |
| value | pH | | 8.3 | 8.3 | 7.8 | 8.1 | 8.2 | 8.1 |
| | Viscosity (mPa · s) | | 180 | 500 | 600 | 210 | 400 | 480 |
| | MFT(° C.) | | 30 | 20 | 7 | 10 | 9 | 7 |
| | Weight average | | 170000 | 50000 | 70000 | 90000 | 80000 | 89000 |
| | molecular weight | | | | | | | |
| | Mechanical stability | | Good | Excellent | Excellent | Excellent | Good | Average |
| | E * (20° C.) | | 5.6 × 10⁸ | 5.5 × 10⁸ | 1.3 × 10⁸ | 0.7 × 10⁸ | 2.2 × 10⁸ | 0.7 × 10⁸ |
| | E * * (20° C.) | | 1.1 × 10⁸ | 1.0 × 10⁸ | 1.1 × 10⁸ | 0.6 × 10⁸ | 1.2 × 10⁸ | 0.6 × 10⁸ |
| | tan δ (20° C.) | | 0.2 | 0.18 | 0.85 | 0.86 | 0.55 | 0.86 |
| | E * (50° C.) | | 5.0 × 10⁵ | 5.0 × 10⁵ | 6.6 × 10⁵ | 2.2 × 10⁵ | 5.9 × 10⁵ | 2.2 × 10⁵ |
| | E * * (50° C.) | | 5.3 × 10⁵ | 5.3 × 10⁵ | 5.5 × 10⁵ | 2.1 × 10⁵ | 4.5 × 10⁵ | 2.1 × 10⁵ |
| | tan δ (50° C.) | | 1.05 | 1.05 | 0.83 | 0.95 | 0.75 | 0.95 |
| | tan δ MAX | | 2.3 | 2.5 | 1.6 | 1.9 | 1.5 | 1.9 |
| | Temperature of | | 40 | 40 | 36 | 30 | 39 | 36 |
| | tan δ MAX(° C.) | | | | | | | |
| | Vibration | 20° C. | 0.025 | 0.025 | 0.067 | 0.075 | 0.077 | 0.076 |
| | damping property | 40° C. | 0.130 | 0.132 | 0.162 | 0.136 | 0.143 | 0.138 |
| | (loss coefficient) | 60° C. | 0.078 | 0.076 | 0.064 | 0.070 | 0.065 | 0.062 |

| | | | | | | |
|---|---|---|---|---|---|---|
| Total loss coefficient | 0.233 | 0.233 | 0.293 | 0.281 | 0.285 | 0.276 |

TABLE 2

| | | | Example | | | | | |
|---|---|---|---|---|---|---|---|---|
| | | | 7 | 8 | 9 | 10 | 11 | 12 |
| 1 st stage | 2EHA | | 15.0 | 12.0 | 12.0 | 13.5 | 35.0 | 5.0 |
| (unit: part) | St | | — | — | — | 17.0 | 64.0 | 17.5 |
| | MMA | | 25.0 | 20.0 | 20.0 | 14.0 | — | 6.0 |
| | BA | | — | — | — | — | — | 25.0 |
| | TMPTMA | | — | — | — | — | — | — |
| | AA | | 0.5 | 0.5 | 0.5 | — | 1.0 | 1.0 |
| | MAA | | — | — | — | 1.0 | — | — |
| | n-BMA | | 10.0 | 10.0 | 10.0 | — | — | — |
| | t-DM | | 0.2 | 0.2 | 0.2 | 0.2 | — | 0.2 |
| | Total | | 50.7 | 42.7 | 42.7 | 45.7 | 100.0 | 54.7 |
| 2 nd stage | 2EHA | | 12.0 | 13.0 | 13.0 | 5.0 | — | 13.5 |
| (unit: part) | St | | — | — | — | 17.5 | — | 17.0 |
| | MMA | | 10.0 | 17.0 | 17.0 | 6.0 | — | 14.0 |
| | BA | | 10.0 | 10.0 | 10.0 | 25.0 | — | — |
| | TMPTMA | | | | | | | — |
| | AA | | 1.0 | 1.0 | 1.0 | — | — | — |
| | MAA | | — | — | — | 1.0 | — | 1.0 |
| | n-BMA | | 16.5 | 16.5 | 16.5 | — | — | — |
| | t-DM | | 0.2 | 0.2 | 0.2 | 0.2 | — | 0.2 |
| | Total | | 49.7 | 57.7 | 57.7 | 54.7 | 0.0 | 45.7 |
| 1 st stage, | 2EHA | | 27.0 | 25.0 | 25.0 | 13.5 | 35.0 | 18.5 |
| 2 nd stage | St | | — | — | — | 34.5 | 64.0 | 34.5 |
| Total | MMA | | 35.0 | 37.0 | 37.0 | 20.0 | — | 20.0 |
| (unit: part) | BA | | 10.0 | 10.0 | 10.0 | 30.0 | — | 25.0 |
| | TMPTMA | | — | — | — | — | 1.0 | — |
| | AA | | 1.5 | 1.5 | 1.5 | — | — | 1.0 |
| | MAA | | — | — | — | 2.0 | — | 1.0 |
| | n-BMA | | 26.5 | 26.5 | 26.5 | — | — | — |
| | t-DM | | 0.4 | 0.4 | 0.4 | 0.4 | — | 0.4 |
| | Subtotal | | 100.4 | 100.4 | 100.4 | 100.4 | 100.0 | 100.4 |
| | Used emulsifier | | A | C | E | A | A | A |
| Calculation | 1 st stage Tg | | 15 | 15 | 15 | 27 | 15 | 27 |
| Tg | 2 nd stage Tg | | −13 | −4 | −4 | −7 | — | −7 |
| | Total Tg | | 0 | 4 | 4 | 9 | 15 | 9 |
| | Δ Tg | | 28 | 20 | 20 | 34 | — | 34 |
| Characteristic | NV(%) | | 55.1 | 55.0 | 54.7 | 54.7 | 54.9 | 54.8 |
| value | pH | | 8.2 | 8.2 | 7.9 | 7.9 | 8.4 | 8.0 |
| | Viscosity (mPa · s) | | 230 | 310 | 410 | 150 | 300 | 160 |
| | MFT(° C.) | | 7 | 9 | 7 | 12 | 25 | 20 |
| | Weight average | | 80000 | 78000 | 82000 | 82000 | 300000 | 80000 |
| | molecular weight | | | | | | | |
| | Mechanical stability | | Good | Excellent | Excellent | Good | Good | Good |
| | E * (20° C.) | | 0.9 × 10⁸ | 0.9 × 10⁸ | 0.8 × 10⁸ | 2.2 × 10⁸ | 5.6 × 10⁸ | 2.3 × 10⁸ |
| | E * * (20° C.) | | 0.8 × 10⁸ | 0.8 × 10⁸ | 0.8 × 10⁸ | 1.2 × 10⁸ | 1.0 × 10⁸ | 1.4 × 10⁸ |
| | tan δ (20° C.) | | 0.89 | 0.94 | 1.0 | 0.55 | 0.18 | 0.61 |
| | E * (50° C.) | | 5.2 × 10⁵ | 5.0 × 10⁵ | 4.7 × 10⁵ | 3.0 × 10⁶ | 4.0 × 10⁶ | 5.6 × 10⁵ |
| | E * * (50° C.) | | 4.0 × 10⁵ | 3.8 × 10⁵ | 3.6 × 10⁵ | 3.2 × 10⁶ | 4.2 × 10⁶ | 4.3 × 10⁵ |
| | tan δ (50° C.) | | 0.78 | 0.76 | 0.77 | 1.07 | 1.05 | 0.77 |
| | tan δ MAX | | 1.4 | 1.4 | 1.4 | 1.5 | 2.0 | 1.6 |
| | Temperature of | | 36 | 36 | 34 | 39 | 40 | 40 |
| | tan δ MAX(° C.) | | | | | | | |
| | Vibration | 20° C. | 0.075 | 0.076 | 0.083 | 0.072 | 0.020 | 0.080 |
| | damping property | 40° C. | 0.149 | 0.150 | 0.157 | 0.148 | 0.104 | 0.160 |
| | (loss coefficient) | 60° C. | 0.072 | 0.074 | 0.065 | 0.073 | 0.095 | 0.060 |

| | | | | | | |
|---|---|---|---|---|---|---|
| Total loss coefficient | 0.296 | 0.300 | 0.305 | 0.293 | 0.219 | 0.300 |

TABLE 3

| | | | Comparative Example | | | | | | |
|---|---|---|---|---|---|---|---|---|---|
| | | | 1 | 2 | 3 | 4 | 5 | 6 | 7 |
| 1 st stage | 2EHA | | 35.0 | 4.0 | 3.0 | 23.0 | 5.6 | 80.3 | 18.5 |
| (unit: part) | St | | 65.0 | 35.0 | 36.0 | 12.0 | 88.4 | 18.7 | 80.5 |
| | MMA | | — | — | — | — | — | — | — |
| | BA | | — | — | — | — | — | — | — |
| | GMA | | — | — | — | — | 5.0 | — | — |
| | TMPTMA | | — | — | — | — | — | 5.0 | — |
| | AA | | — | 1.0 | 1.0 | 0.5 | 1.0 | 1.0 | 1.0 |
| | MAA | | — | — | — | — | — | — | — |
| | n-BMA | | — | — | — | — | — | — | — |
| | t-DM | | 0.2 | 0.2 | 0.2 | 0.2 | — | 0.4 | 10.0 |
| | Total | | 100.2 | 40.2 | 40.2 | 35.7 | 100.0 | 105.4 | 110.0 |
| 2 nd stage | 2EHA | | — | 16.5 | 36.0 | — | — | — | — |
| (unit: part) | St | | — | 43.0 | — | 16.0 | — | — | — |
| | MMA | | — | — | 23.0 | — | — | — | — |
| | BA | | — | — | — | 48.0 | — | — | — |
| | AA | | — | 0.5 | 1.0 | 0.5 | — | — | — |
| | MAA | | — | — | — | — | — | — | — |
| | n-BMA | | — | — | — | — | — | — | — |
| | t-DM | | — | 0.2 | 0.2 | 0.2 | — | — | — |
| | Total | | 0.0 | 60.2 | 60.2 | 64.7 | 0.0 | 0.0 | 0.0 |
| 1 st stage, | 2EHA | | 35.0 | 20.5 | 39.0 | 23.0 | 5.6 | 80.3 | 18.5 |
| 2 nd stage | St | | 65.0 | 78.0 | 36.0 | 28.0 | 88.4 | 18.7 | 80.5 |
| Total | MMA | | — | — | 23.0 | — | — | — | — |
| (unit: part) | BA | | — | — | — | 48.0 | — | — | — |
| | GMA | | — | — | — | — | 5.0 | — | — |
| | TMPTMA | | — | 1.5 | 2.0 | 1.0 | — | 5.0 | — |
| | AA | | — | — | — | — | 1.0 | 1.0 | 1.0 |
| | MAA | | — | — | — | — | — | — | — |
| | n-BMA | | — | — | — | — | — | — | — |
| | t-DM | | 0.2 | 0.4 | 0.4 | 0.4 | — | 0.4 | 10.0 |
| | Subtotal | | 100.2 | 100.4 | 100.4 | 100.4 | 100.0 | 105.4 | 110.0 |
| | Used emulsifier | | A | A | A | A | A | A | A |
| Calculation | 1 st stage Tg | | 15 | 71 | 78 | −1 | 80 | −50 | 5 |
| Tg | 2 nd stage Tg | | — | 30 | −24 | −47 | — | — | — |
| | Total Tg | | 15 | 45 | 9 | −30 | 80 | −50 | 5 |
| | Δ Tg | | — | 41 | 102 | 46 | — | — | — |
| Characteristic | NV(%) | | — | 54.5 | 54.8 | 54.6 | 54.5 | 54.4 | 54.3 |
| value | pH | | — | 7.7 | 7.5 | 8.2 | 7.6 | 7.3 | 8.3 |
| | Viscosity (mPa · s) | | — | 430 | 250 | 660 | 120 | 760.0 | 800.0 |
| | MFT(° C.) | | — | 55 | 15 | <0 | >100 | <0 | 40.0 |
| | Weight average | | — | 91000 | 96000 | 92000 | No | 86000 | 5000 |
| | molecular weight | | | | | | measurement | | |
| | Mechanical stability | | — | Bad | Average | Average | Excellent | Good | Good |
| | E * (20° C.) | | — | 1.8 × 10⁹ | 1.4 × 10⁸ | 5.7 × 10⁶ | 2.1 × 10⁹ | 2.0 × 10⁹ | 1.5 × 10⁹ |
| | E * * (20° C.) | | — | 1.3 × 10⁸ | 7.7 × 10⁸ | 4.2 × 10⁵ | 7.3 × 10⁷ | 1.0 × 10⁵ | 1.1 × 10⁷ |
| | tan δ (20° C.) | | — | 0.08 | 0.56 | 0.73 | 0.035 | 0.1 | 0.007 |
| | E * (50° C.) | | — | 8.7 × 10⁶ | 2.5 × 10⁷ | — | 3.2 × 10⁷ | 3.5 × 10⁴ | 5.3 × 10⁵ |
| | E * * (50° C.) | | — | 1.8 × 106 | 1.2 × 10⁷ | — | 5.8 × 10⁷ | 1.0 × 10³ | 1.2 × 10⁵ |
| | tan δ (50° C.) | | — | 0.21 | 0.46 | — | 1.8 | 0.029 | 0.23 |
| | tan δ MAX | | — | 1.9 | 0.6 | 2.0 | 2.9 | 3.0 | 3.1 |
| | Temperature of | | — | 75 | 20 | 0.0 | 89 | −18 | 32 |
| | tan δ MAX(° C.) | | | | | | | | |
| | Vibration | 20° C. | — | — | 0.010 | — | — | 0.007 | 0.003 |
| | damping property | 40° C. | — | — | — | — | 0.010 | 0.005 | 0.145 |
| | (loss coefficient) | 60° C. | — | 0.002 | — | — | 0.070 | 0.002 | 0.012 |

| | | | | | | | |
|---|---|---|---|---|---|---|---|
| Total loss coefficient | — | — | — | — | — | 0.014 | 0.160 |

In Tables 1 to 3, t-DM represents t-dodecyl mercaptan. Other abbreviations represent the same abbreviations as those mentioned in the above-mentioned Tg evaluation method.

The emulsifiers A to E in Tables 1 to 3 are as follows.

A: NEWCOL 707SF (trade name, polyoxyethylene polycyclic phenyl ether ammonium sulfate, product of Nippon Nyukazai Co., Ltd.)
B: ABEX-26S (trade name, polyoxyethylene alkyl phenyl ether sulfate, product of Rhodia Nikka Co., Ltd.)
C: LATEMUL WX (trade name, polyoxyethylene oleyl ether sulfate, product of Kao Corp.)
D: EMULGEN 1118S (trade name, polyoxyethylene alkyl ether, (ethylene oxide 18 mol adduct), product of Kao Corp.)
E: ADEKA REASOAP SR-10 (trade name, allyloxymethyl alkoxy ethyl polyoxyethylene sulfate, product of ADEKA Corp.)

1. An emulsion for vibration damping materials, comprising an emulsion obtainable by emulsion polymerization of a monomer component,
wherein the emulsion has a storage modulus value of 5.0×10⁷ to 8.0×10⁸ Pa at 20° C. and a storage modulus value of 1.0×10⁵ to 5.0×10⁶ Pa at 50° C.,
the emulsion has a loss modulus value of 4.0×10⁷ to 4.0×10⁸ Pa at 20° C. and a loss modulus value 1.0×10⁵ to 7.0×10⁶ Pa at 50° C.,
the emulsion has a maximum peak of a loss tangent of 1.3 or more in a range from 20 to 50° C., and
a vibration damping composition including the emulsion has an aggregation ratio of 0.01 or less,
the aggregation ratio being measured by a mechanical stability test in accordance with JIS K6828:1996.

2. The emulsion for vibration damping materials according to claim 1,
wherein the emulsion has a minimum film-forming temperature of 30° C. or less.
